(19) United States
(12) Patent Application Publication
(10) Pub. No.: US 2026/0228076 A1
(43) Pub. Date: Aug. 6, 2026

(54) FAULT RECOVERY OF PERIPHERAL INPUT/OUTPUT LINES

(71) Applicant: QUALCOMM Incorporated, San Diego, CA (US)

(72) Inventors: Santhosh Reddy AKAVARAM, Hyderabad (IN); Chintalapati BHARATH SAI VARMA, Hyderabad (IN); Sang TRAN, Encinitas, CA (US); Mukesh Kumar Pravinbhai SAVALIYA, Hyderabad (IN); Bhavya SONETA, Indore (IN); Akshay GOYAL, Bijnor (IN)

(21) Appl. No.: 19/044,927

(22) Filed: Feb. 4, 2025

(51) Int. Cl. G06F 11/07

(52) U.S. Cl. CPC G06F 11/0772; G06F 11/0757; G06F 11/0793

(57) ABSTRACT

A peripheral interconnect subsystem includes an input/output controller that is coupled to slave devices via peripheral input/output lines. The peripheral interconnect subsystem includes a monitoring circuit that is coupled to the peripheral input/output lines. The monitoring circuit generates a control signal having a first state based on a deviation of at least one of the peripheral input/output lines from a default state. The monitoring circuit generates an interrupt based on the control signal having the first state upon a lapse of a time-period.

### BACKGROUND

### Field of the Disclosure

The present disclosure relates generally to electronic systems, and, more particularly, to recovery of faulty peripheral input/output lines in electronic systems.

### Description of Related Art

In today's technology landscape, devices across domains such as automotive, Internet of Things (IoT), mobile, or the like, depend on seamless communication to exchange data between processors (e.g., master devices) and peripherals (e.g., slave devices). With diverse communication protocols being utilized within a single electronic system, integrating multiple communication standards becomes challenging. Thus, a peripheral interconnect subsystem capable of supporting multiple communication protocols can be coupled between the master devices and the slave devices to enable seamless communication. The peripheral interconnect subsystem typically includes controllers that are configurable to support various communication protocols, such as serial protocols, for example, Inter-Integrated Circuit (I2C) or Improved Inter-Integrated Circuit (I3C) protocols. The controllers are coupled to multiple slave devices by way of input/output lines. Upon configuring a communication protocol on a controller, input/output lines associated with the communication protocol are activated and typically set to a default state, signifying readiness for communication. For example, in serial communication protocols such as I2C/I3C, data (Serial Data Line “SDA”) and clock (Serial Clock Line “SCL”) lines are expected to remain high when idle. The activation of the input/output lines enables communication between a master device and slave device(s) by means of the controller.

However, oftentimes, the input/output lines connecting a controller to the slave device(s) deviate from the default state. For example, one or more input/output lines can be pulled to incorrect voltage levels due to noise or voltage fluctuations. Such deviation of the input/output lines from the default state can lead to potential issues in data transfer.

### SUMMARY

Aspects of the disclosure provide a peripheral interconnect subsystem. The peripheral interconnect subsystem may comprise an input/output controller. The input/output controller may be coupled to one or more slave devices via a set of input/output lines. The peripheral interconnect subsystem may further comprise a monitoring circuit coupled to the set of input/output lines. The monitoring circuit may be configured to generate a control signal having a first state based on a deviation of at least one input/output line of the set of input/output lines from a default state. The monitoring circuit may be further configured to generate an interrupt based on the control signal having the first state upon a lapse of a time-period.

In certain aspects of the disclosure, a system-on-chip (SoC) is disclosed. The SoC may comprise one or more processing cores and a peripheral interconnect subsystem. The peripheral interconnect subsystem may be coupled between the one or more processing cores and one or more slave devices. The peripheral interconnect subsystem may comprise at least one input/output controller coupled to the one or more slave devices via a set of input/output lines. The at least one input/output controller may be configured to control data transfer between at least one processing core of the one or more processing cores and the one or more slave devices via the set of input/output lines. The peripheral interconnect subsystem may further comprise at least one monitoring circuit coupled to the set of input/output lines. The at least one monitoring circuit may be configured to generate a control signal having a first state based on a deviation of at least one input/output line of the set of input/output lines from a default state. The at least one monitoring circuit may be further configured to generate an interrupt based on the control signal having the first state upon a lapse of a time-period.

In certain aspects, a method executed at a peripheral interconnect subsystem is disclosed. The method may comprise generating a control signal having a first state based on a deviation of at least one input/output line of a set of input/output lines from a default state. The set of input/output lines couples an input/output controller in the peripheral interconnect subsystem to one or more slave devices. The method may further comprise generating an interrupt based on the control signal having the first state upon a lapse of a time-period.

### BRIEF DESCRIPTION OF THE DRAWINGS

Various aspects of the present disclosure are illustrated by way of example, and not limited by the appended figures, in which like references indicate similar elements:

FIG. 1 is a schematic block diagram of an electronic device, in accordance with certain aspects of the present disclosure;

FIG. 2 is a block diagram of a peripheral interconnect subsystem of the electronic device of FIG. 1, in accordance with certain aspects of the present disclosure;

FIG. 3 is a flowchart that illustrates a method (e.g., a process) executed by one or more processing cores of the electronic device of FIG. 1, in accordance with an exemplary aspect of the present disclosure;

FIG. 4 is a flowchart that illustrates a method (e.g., a process) executed based on a configuration of a communication protocol on an input/output controller of the peripheral interconnect subsystem of FIG. 2, in accordance with an exemplary aspect of the present disclosure;

FIG. 5 is a high-level flowchart that illustrates a method (e.g., a process) executed at the peripheral interconnect subsystem of FIG. 2, in accordance with an exemplary aspect of the present disclosure;

FIG. 6 is a detailed flowchart that illustrates a method (e.g., a process) executed by a monitoring circuit of the peripheral interconnect subsystem of FIG. 2, in accordance with an exemplary aspect of the present disclosure; and

FIG. 7 is a flowchart that illustrates a method (e.g., a process) executed by a timing circuit of the peripheral interconnect subsystem of FIG. 2, in accordance with an exemplary aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

In today's technology landscape, multiple communication protocols are often integrated within a single electronic system or device. Thus, to facilitate seamless communication between master devices in the electronic system and slave devices, a peripheral interconnect subsystem that supports multiple communication protocols is coupled between the master devices and the slave devices. The peripheral interconnect subsystem typically includes controllers that are configurable to support various communication protocols. The master devices communicate with the slave devices by means of such configurable controllers. The controllers are coupled to the slave devices via peripheral input/output lines. When a controller is configured with a communication protocol, peripheral input/output lines associated with the communication protocol are activated and typically set to a default state. Thus, data transfer between the master devices and the slave devices through the controller is enabled.

The data transfer occurs based on the peripheral input/output lines being in the default state. However, the input/output lines connecting a controller to the slave device(s) may deviate from the default state. For example, one or more input/output lines can be pulled to incorrect voltage levels due to noise or voltage fluctuations or at least one of the slave devices transitioning into an erroneous state. Such deviation of the input/output lines from the default state can lead to potential issues in data transfer. Thus, the master devices may execute various operations for fault detection and recovery. For example, when a master device initiates data transfer to the slave device(s), the master device triggers a timer with a timeout period to ensure the data transfer finishes within the expected time. The triggered timeout period can vary depending on various factors such as the communication protocol and speed, a size of data to be transferred, device characteristics of the slave devices, a type of application running on the master device, or the like. The master device may then poll for a timer timeout event. During polling, if the master device determines that the timer has timed out without the completion of the data transfer, the master device may check a current state of the input/output lines and determine if any input/output line has deviated from an expected default state. If the current state of the input/output lines indicates that one or more input/output lines have deviated from the expected default state, the master device may execute a bus clean-up sequence to recover the faulty peripheral input/output lines and re-establish the default state of the peripheral input/output lines. Though the master device is able to detect and address the faults in the input/output lines, relying on the timer, polling, and subsequent bus recovery can still impose processing overhead on the master device and increase power consumption in the electronic system. In addition, while the master device is polling the timer event, the master device is unable to execute other operations.

Certain aspects disclosed herein provide methods, circuits and systems that are adapted to enable fault recovery of input/output lines. For example, fault detection can be offloaded from one or more processing cores (e.g., master devices) to a peripheral interconnect subsystem that couples the one or more processing cores to one or more slave devices via a set of input/output lines. The processing cores can initiate data transfer with the one or more slave devices via the peripheral interconnect subsystem and the set of input/output lines. The peripheral interconnect subsystem may include an input/output controller coupled to the one or more slave devices via the set of input/output lines. The peripheral interconnect subsystem may further include a monitoring circuit coupled to the set of input/output lines, and configured to detect a fault in the set of input/output lines. For example, the monitoring circuit may generate a control signal having a first state based on a deviation of at least one input/output line of the set of input/output lines from a default state. The monitoring circuit may further generate an interrupt based on the control signal having the first state upon a lapse of a time-period. In other words, if the set of input/output lines fails to attain the default state at the end of the time-period, the monitoring circuit may generate the interrupt.

Thus, by offloading fault detection in the set of input/output lines from the processing cores to the monitoring circuit, the processing overhead imposed on the processing cores due to polling of timer timeout events is eliminated, which may reduce the overall power consumption, and improve performance of the electronic system. Further, once the data transfer is initiated, the processing cores become available for execution of other tasks, thus, improving resource utilization in the electronic system. Furthermore, as the monitoring circuit is coupled to the set of input/output lines, fault detection latency associated with the monitoring circuit is less as compared to the fault detection latency of the processing cores, which in turn can lead to faster fault recovery. Further, the monitoring circuit can detect faults in the set of input/output lines during any of an available, busy, or idle status of the set of input/output lines. Thus, the fault detection is independent of a data transfer status of the set of input/output lines.

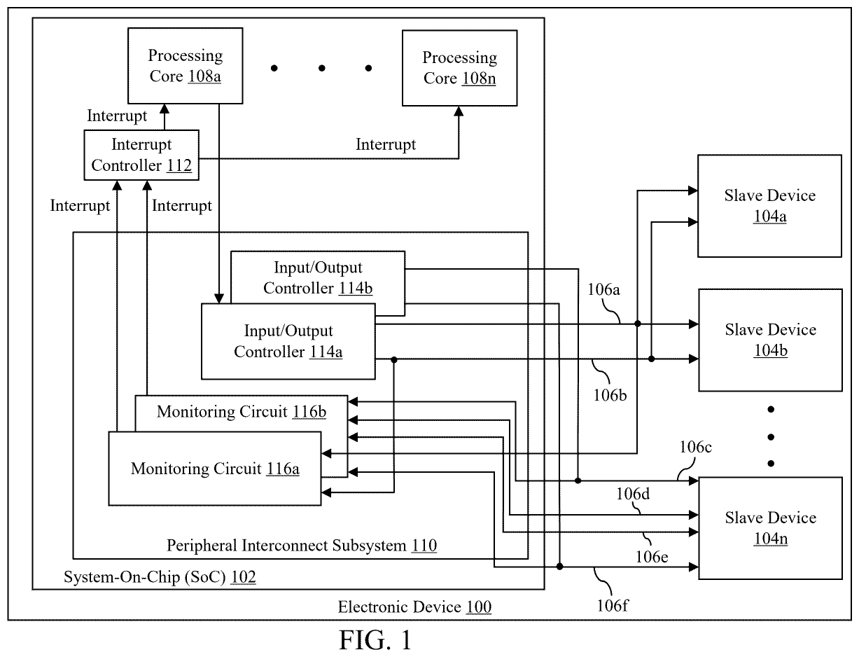

FIG. 1 is a schematic block diagram of an electronic device 100, in accordance with certain aspects of the present disclosure. The electronic device 100 may include a system-on-chip (SoC) 102 and one or more slave devices 104a-104n such as a slave device 104a, a slave device 104b, and a slave device 104n. The electronic device 100 may further include a plurality of input/output lines 106a-106f. The plurality of input/output lines 106 a-106f may include an input/output line 106a, an input/output line 106b, an input/output line 106c, an input/output line 106d, an input/output line 106e, and an input/output line 106f. The SoC 102 may be coupled to the one or more slave devices 104a-104n (e.g., peripheral devices) via the plurality of input/output lines 106a-106f. In certain aspects, the electronic device 100 may be implemented in automotive systems, home automation systems, mobile devices, robotic systems, healthcare systems, immersive reality systems, or the like. However, it will be understood by a person skilled in the art that the electronic device 100 may be implemented in various additional or alternate systems. Further, the electronic device 100 may be a cellular phone, a smartphone, a laptop, a notebook, a tablet, a phablet, a personal digital assistant, a satellite radio, a global positioning system device, a smart home device, intelligent lighting, a multimedia device, a video device, a digital audio player, a camera, a game console, an entertainment device, a vehicle component, a wearable computing device (e.g., a smartwatch, a health or fitness tracker, or eyewear), an appliance, a security device, a vending machine, a smart meter, or any other similar functioning device.

The SoC 102 may be a processing chip that may integrate multiple components, which are arranged to facilitate desired functions of the SoC 102. The components may include processing cores, a system bus, a central processing unit (CPU), control and status registers, clock circuitry, input/output interfaces, communication protocol managing units, memory access management circuitry, an interrupt handler, timing circuits, or the like. In accordance with certain aspects of the present disclosure, the SoC 102 may include one or more processing cores 108a-108n such as a processing core 108a and a processing core 108n. The SoC 102 may further include a peripheral interconnect subsystem 110 and an interrupt controller 112.

In certain aspects, a host processor of the SoC 102, such as a CPU, may be configured to load a firmware associated with a communication protocol on the peripheral interconnect subsystem 110. In other words, the peripheral interconnect subsystem 110 may receive a configuration of the communication protocol from the host processor. The communication protocol may be received to establish communication between the SoC 102 and the one or more slave devices 104a-104n. The communication may include one of a read operation, a write operation, or the like. Upon receiving the configuration of the communication protocol, various parameters associated with the communication protocol may be configured in the peripheral interconnect subsystem 110. In an example, a clock speed for communication with the one or more slave devices 104a-104n may be configured, input/output pins associated with the communication protocol may be enabled in the peripheral interconnect subsystem 110, registers of the peripheral interconnect subsystem 110 may be loaded with statuses of at least one of the plurality of input/output lines 106a-106f, or the like.

The communication protocol may be a serial communication protocol that may be based on at least one of Inter-Integrated Circuit (I2C), Improved Inter-Integrated Circuit (I3C), Serial Peripheral Interface (SPI), Quad SPI (QSPI), Octal SPI (OSPI), Dual Quad SPI, Expanded SPI (XSPI), Universal Asynchronous Receiver-Transmitter (UART), or the like. Though the examples provided herein are for a serial communication protocol, in various additional aspects, the communication protocol may be a parallel communication protocol.

In certain aspects, the communication protocol may be configured in the peripheral interconnect subsystem 110 based on a compatibility of the one or more slave devices 104a-104n to communicate with the SoC 102 via the communication protocol. In other words, the host processor may identify a communication protocol supported by each of the one or more slave devices 104a-104n and configure the identified communication protocol in the peripheral interconnect subsystem 110. Thus, the data transfer between the one or more slave devices 104a-104n and the SoC 102 may occur based on the communication protocol.

In one aspect, the communication protocol that may be identified by the host processor may be a default communication protocol of each of the one or more slave devices 104a-104n. Further, the communication protocol may be configured during a boot-up of the electronic device 100. In an example, the host processor may identify that the slave device 104a supports the I2C communication protocol. Thus, the host processor may configure the peripheral interconnect subsystem 110 with the I2C communication protocol to enable the communication between the slave device 104a and the SoC 102. If the host processor further identifies that the slave device 104n supports the SPI communication protocol, the host processor may further configure the peripheral interconnect subsystem 110 with the SPI communication protocol to enable the communication between the slave device 104n and the SoC 102. The configuration of the peripheral interconnect subsystem 110 with multiple communication protocols has been explained in the ongoing description.

In further aspects, at least one of the one or more slave devices 104a-104n may support multiple communication protocols. In an example, the host processor may thus switch between the configuration of the communication protocols on the peripheral interconnect subsystem 110 based on an application of the slave device. For the sake of simplicity of the ongoing description and in a non-limiting example, it is assumed that the slave devices 104a and 104b support the I2C communication protocol whereas the slave device 104n supports the SPI communication protocol. However, in various additional aspects, the slave devices 104a and 104b may support a communication protocol that is different than the I2C communication protocol whereas the slave device 104n may support a communication protocol that is different than the SPI communication protocol.

The one or more processing cores 108a-108n may include suitable logic, circuitry, interfaces, and/or codes executable by the circuitry, for executing applications and/or instructions to perform functions associated with the one or more processing cores 108a-108n. The one or more processing cores 108a-108n may be master device(s) of the SoC 102. The one or more processing cores 108a-108n may be configured to communicate with the one or more slave devices 104a-104n via the peripheral interconnect subsystem 110 and the plurality of input/output lines 106a-106f.

In certain aspects, the one or more processing cores 108a-108n may be further configured to receive instructions from the host processor to initiate communication with the one or more slave devices 104a-104n. In further aspects, based on an application executed by the one or more processing cores 108a-108n, the one or more processing cores 108a-108n may trigger the communication with the one or more slave devices 104a-104n. In many further aspects, the one or more processing cores 108a-108n may trigger the communication with the one or more slave devices 104a-104n based on an external trigger, a user input, or the like. The one or more processing cores 108a-108n may be further configured to provide communication parameters such as an identifier of the one or more slave devices 104a-104n, a type of data transfer, or the like, to the peripheral interconnect subsystem 110 upon the initiation of the communication.

In several aspects, the one or more processing cores 108a-108n may access the peripheral interconnect subsystem 110 concurrently, thereby enabling concurrently processing of various functions associated with the one or more processing cores 108a-108n. The one or more processing cores 108a-108n may be further configured to generate data packets for the one or more slave devices 104a-104n to execute at least one function associated with the corresponding processing core. In certain aspects, the one or more processing cores 108a-108n may include audio/video processing cores, secure processors, application processors, or the like. In an example, the processing core 108a may be a low-power audio system that may execute functions associated with processing of an audio. Further, the processing core 108a may provide the data packets to the peripheral interconnect subsystem 110 to execute at least one function associated with the processing of the audio. In further examples, the processing core 108n may be a secure processor configured to generate data packets associated with execution of cryptographic operations.

In numerous aspects, each of the one or more processing cores 108a-108n may be associated with a corresponding execution environment. In other words, each of the one or more processing cores 108a-108n may be assigned a plurality of unique addresses of a memory associated with the SoC 102. In addition, each of the one or more processing cores 108a-108n may be configured to receive an interrupt from the peripheral interconnect subsystem 110 via the interrupt controller 112. The interrupt may be received via an interrupt line of each of the one or more processing cores 108a-108n. Further, each of the one or more processing cores 108a-108n may independently receive the interrupt from the interrupt controller 112 without affecting the functions of the other processing cores or the host processor. The one or more processing cores 108a-108n may be further registered (e.g., configured) by the host processor for receiving the interrupt prior to the communication between the one or more processing cores 108a-108n and the one or more slave devices 104a-104n via the peripheral interconnect subsystem 110.

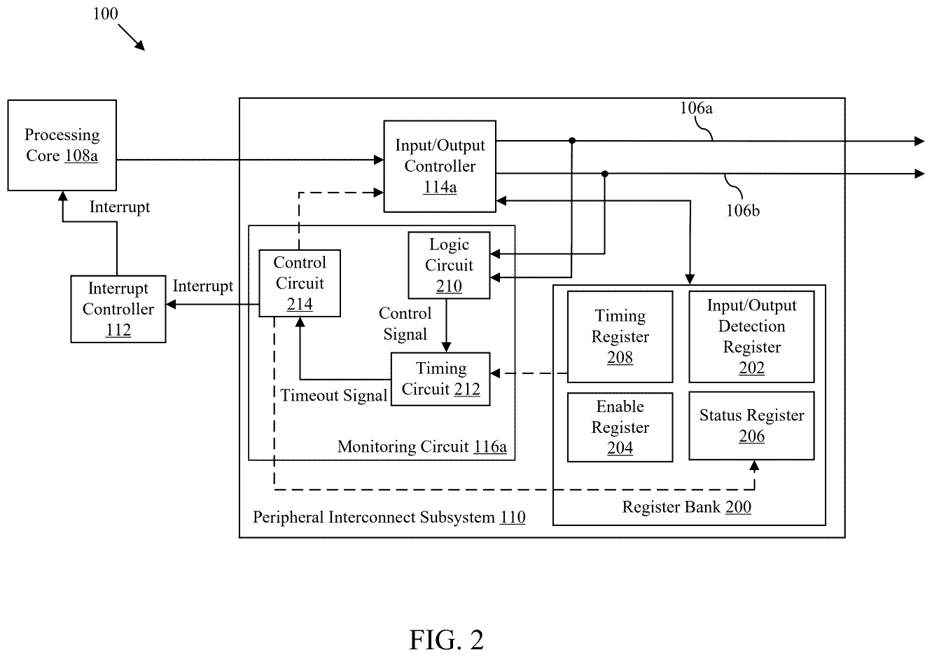

Upon receiving the interrupt, the one or more processing cores 108a-108n may be further configured to execute a bus clean-up sequence to clear a faulty state of at least one input/output line of the plurality of input/output lines 106a-106f. The faulty state of an input/output line may indicate a deviation of an input/output line from a default state upon a lapse of a time-period as explained in the ongoing description. Further, the one or more processing cores 108a-108n may halt the transmission of the data packets to the peripheral interconnect subsystem 110 based on the reception of the interrupt. Upon clearing the faulty state of the at least one of the plurality of input/output lines 106a-106f, the one or more processing cores 108a-108n may re-initiate the transmission of the data packets to the peripheral interconnect subsystem 110. The generation of the interrupt is explained in FIG. 2. Examples of the one or more processing cores 108a-108n may include, but are not limited to, an application-specific integrated circuit (ASIC) processor, a reduced instruction set computer (RISC) processor, a complex instruction set computer (CISC) processor, a field programmable gate array (FPGA), or the like. Though it is mentioned that the host processor may configure the communication protocol in the peripheral interconnect subsystem 110, in further aspects, the one or more processing cores 108a-108n can also configure the communication protocol in the peripheral interconnect subsystem 110.

The peripheral interconnect subsystem 110 may be coupled to the one or more processing cores 108a-108n. The peripheral interconnect subsystem 110 may be further coupled to the one or more slave devices 104a-104n via the plurality of input/output lines 106a-106f. The peripheral interconnect subsystem 110 may be further configured to facilitate communication between the one or more processing cores 108a-108n and the one or more slave devices 104a-104n via various communication protocols. The peripheral interconnect subsystem 110 may be further configured to support a plurality of peripheral interfaces such as serial interfaces, based on the communication protocols. The components of the peripheral interconnect subsystem 110 may include memories, registers, processors, interfaces, serial communication units, serializer/deserializer, virtualization and memory management components, or the like, that may be coupled to each other.

In accordance with certain aspects of the present disclosure, the peripheral interconnect subsystem 110 may include a plurality of input/output controllers 114a and 114b of which an input/output controller 114a and an input/output controller 114b are shown. A number of the plurality of input/output controllers 114a and 114b supported by the peripheral interconnect subsystem 110 may be based on a number of communication protocols supported by the peripheral interconnect subsystem 110. Thus, each input/output controller may be configured to conform to at least one of the communication protocols. In an example, the number of the plurality of input/output controllers 114a and 114b may be eight corresponding to eight serial communication protocols such as I2C, I3C, SPI, QSPI, OSPI, Q2SPI, XSPI, and UART; however, the scope of the disclosure is not limited to the number of the plurality of input/output controllers 114a and 114b being eight.

The peripheral interconnect subsystem 110 may be further configured to receive data packets from the one or more processing cores 108a-108n for communication with the one or more slave devices 104a-104n. The data packets may be queued in data buffers associated with the peripheral interconnect subsystem 110. The peripheral interconnect subsystem 110 may be further configured to generate the interrupt based on the deviation of at least one of the plurality of input/output lines 106a-106f from the default state as explained in the ongoing description. Upon generation of the interrupt, the peripheral interconnect subsystem 110 may clear the queued data packets from the buffers thereby revoking the transmission of the data packets to the one or more slave devices 104a-104n. The peripheral interconnect subsystem 110 has been explained in detail by way of the components of the peripheral interconnect subsystem 110.

In several aspects, the plurality of input/output controllers 114a and 114b may include suitable circuitry, code, interfaces that may be configured to perform one or more operations. The plurality of input/output controllers 114a and 114b may be coupled to the one or more slave devices 104a-104n via the plurality of input/output lines 106a-106f. The coupling between the plurality of input/output controllers 114a and 114b and the one or more slave devices 104a-104n may be based on the communication protocol. Each input/output controller of the plurality of input/output controllers 114a and 114b may be configured to control data transfer between at least one execution environment associated with the one or more processing cores 108a-108n and the one or more slave devices 104a-104n via the plurality of input/output lines 106a-106f

The plurality of input/output controllers 114a and 114b may be configured with one or more communication protocols by the host processor. In an example, the input/output controller 114a may receive the configuration of the I2C communication protocol and the input/output controller 114b may receive the configuration of the SPI communication protocol. The communication protocol may be configured (i) upon the booting of the electronic device 100, (ii) dynamically based on applications executed by the one or more slave devices 104a-104n, or (iii) based on availability of the plurality of input/output controllers 114a and 114b for communication with the one or more slave devices 104a-104n. However, the scope of the disclosure is not limited to it. Upon receiving the configuration of the communication protocol, various parameters associated with timing and control operations to transfer and receive data may be set or configured in each of the plurality of input/output controllers 114a and 114b.

Each input/output controller of the plurality of input/output controllers 114a and 114b may further include a plurality of pins (e.g., input/output pins) associated with each communication protocol. Further, each pin of the plurality of pins may be associated with a corresponding input/output line of the plurality of input/output lines 106a-106f. At least one of the plurality of pins may be activated based on the configuration of the communication protocol in the corresponding input/output controller whereas the pins associated with other communication protocols may remain deactivated in the corresponding input/output controller. In an example, a protocol controller of each input/output controller may be configured to activate the pins associated with corresponding protocol. Thus, each input/output controller may include multiple protocol controllers such that each protocol controller may activate the pins associated with the corresponding communication protocol. The activation of the pins may correspond to an electrical state of the activated pins being a powered-ON state (e.g., a logic high sate). Further, when a pin is activated, the corresponding input/output line associated with the pin also gets activated. An electrical state of a pin that remains deactivated may be a powered-OFF state (e.g., a logic low sate). In an example, when the input/output controller 114a is configured with the I2C communication protocol, the pins associated with the I2C communication protocol are activated for communication with the one or more slave devices 104a-104n such as the slave device 104a and the slave device 104b. Further, when the input/output pins associated with the I2C communication protocol are activated, a set of input/output lines 106a and 106b of the plurality of input/output lines 106a-106f associated with the activated pins and that conform to the I2C communication protocol may be activated. Similarly, when the input/output controller 114b is configured with the SPI communication protocol, the pins associated with the SPI communication protocol are activated for communication with the one or more slave devices 104a-104n such as the slave device 104n.

A current state of a pin may thus correspond to a current state of the associated input/output line. A current state of each pin may be one of a powered-ON state (e.g. a logic high state) or a powered-OFF state (e.g. a logic low state). The current state of each pin may be a powered-ON state (e.g. a default state) based on a normal or default operation of the associated input/output line. In certain aspects, the current state of at least one pin may deviate from the default state based on a fault in the associated input/output line as explained in FIG. 2.

In various aspects, the peripheral interconnect subsystem 110 may further include a plurality of monitoring circuits 116a and 116b. The plurality of monitoring circuits 116a and 116b may include a monitoring circuit 116a and a monitoring circuit 116b. Each monitoring circuit of the plurality of monitoring circuits 116a and 116b may be associated with a corresponding input/output controller of the plurality of input/output controllers 114a and 114b. For example, the monitoring circuit 116a may be associated with the input/output controller 114a, while the monitoring circuit 116b may be associated with the input/output controller 114b. Thus, a number of the plurality of monitoring circuits 116a and 116b may be equal to a number of the plurality of input/output controllers 114a and 114b. Each monitoring circuit may be configured to monitor a set of input/output lines of the plurality of input/output lines 106a-106f based on the configuration of the communication protocol on the corresponding input/output controller. In an example, the monitoring circuit 116a may be configured to monitor the set of input/output lines 106a and 106b based on the input/output controller 114a being configured with the I2C communication protocol. In further examples, the monitoring circuit 116b may be configured to monitor the set of input/output lines 106c-106f based on the input/output controller 114b being configured with the SPI communication protocol. In certain aspects, the monitoring circuit 116a may be coupled to the set of input/output lines 106a and 106b, while the monitoring circuit 116b may be coupled to the set of input/output lines 106c-106f.

Each monitoring circuit of the plurality of monitoring circuits 116a and 116b may be configured to generate a control signal based on a current state of each input/output line of the corresponding set of input/output lines coupled to the monitoring circuit. The current state of each input/output line of the corresponding set of input/output lines may be a default state in a normal fault-free operation. In an example, the default state of the corresponding set of input/output lines may be the powered-ON state (e.g., a logic high state) based on the activation of the set of input/output lines. In an event that the current state of at least one input/output line of the corresponding set of input/output lines deviates from the default state, the monitoring circuit coupled to the at least one input/output line may generate the control signal having a first state. The deviated state from the default state may be a powered-OFF state or a logic low state. Further, when the current state of each input/output line of the corresponding set of input/output lines is the default state, the monitoring circuit associated with the corresponding set of input/output lines may generate the control signal having a second state. In an example, the control signal may be an internal signal of the monitoring circuit that is not communicated outside the monitoring circuit.

The deviation of the input/output line from the default state may occur due to a fault in the corresponding input/output line. For example, the fault can occur due to a bus timeout that may be caused based on at least one slave device of the one or more slave devices 104a-104n holding the corresponding input/output lines at a logic low state for an extended time duration. The fault may further occur due to at least one of the set of input/output lines being unresponsive to the communication with the corresponding input/output controller, or the like. In an example, the slave device 104a may hold the input/output line 106a at a logic low state for an extended time duration and the slave device 104 n may hold the input/output line 106c at a logic low state for an extended time duration, due to additional time for processing the data packets received from the peripheral interconnect subsystem 110.

Each monitoring circuit of the plurality of monitoring circuits 116a and 116b may be further configured to generate the interrupt based on the control signal having the first state upon the lapse of the time-period. In an example, the monitoring circuit 116a may generate the control signal having the first state if at least one of the set of input/output lines 106a and 106b deviates from the default state. Likewise, the monitoring circuit 116b may generate the control signal having the first state if at least one of the set of input/output lines 106c-106f deviates from the default state. Further, the monitoring circuit 116a may generate the interrupt if the control signal still has the first state upon the lapse of the time-period. Similarly, the monitoring circuit 116b may generate the interrupt if the corresponding control signal has the first state upon the lapse of the time-period. Each of the monitoring circuit 116a and the monitoring circuit 116b may provide the interrupt to the interrupt controller 112. The structure and functioning of the monitoring circuit 116a is explained in detail in FIG. 2.

The plurality of input/output lines 106a-106f may include communication buses (e.g. peripheral input/output lines) of the electronic device 100. The plurality of input/output lines 106a-106f may be configured to enable coupling between the peripheral interconnect subsystem 110 and the one or more slave devices 104a-104n for data transfer. The plurality of input/output lines 106a-106f may be further configured to enable communication of data and control signals between the peripheral interconnect subsystem 110 and the one or more slave devices 104a-104n. Each input/output line of the plurality of input/output lines 106a-106f may be associated with a corresponding input/output controller of the plurality of input/output controllers 114a and 114b. At least one of the plurality of input/output lines 106a-106f may be enabled for communication based on the communication protocol that is configured for communication with the one or more slave devices 104a-104n. In an example, when at least one of the plurality of input/output lines 106a-106f may be activated, e.g., at a powered-ON state or a logic high state, communication may be enabled via the plurality of input/output lines 106a-106f. In an example, the set of input/output lines 106a and 106b may be associated with the I2C communication protocol whereas the set of input/output lines 106c-106f may be associated with the SPI communication protocol. Further, the set of input/output lines 106a and 106b may be activated based on the configuration of the I2C communication protocol on the input/output controller 114a and the set of input/output lines 106c-106f may be activated based on the configuration of the SPI communication protocol on the input/output controller 114b. Further, when the communication protocol is I2C, the input/output line 106a and the input/output line 106b may be a serial data line and a serial clock line, respectively. Further, when the communication protocol is SPI, the input/output line 106c may be a slave select/chip select line, the input/output line 106d may be a serial clock line, the input/output line 106e may be a master-out-slave-in line, and the input/output line 106f may be a master-in-slave-out line. Though the examples herein are with reference to the I2C and the SPI communication protocols, the input/output lines associated with additional or alternate communication protocols will be understood by a person skilled in the art.

A status of an input/output line of the plurality of input/output lines 106a-106f may correspond to one of available, busy, or idle. An available status of any of the plurality of input/output lines 106a-106f may indicate to the one or more processing cores 108a-108n that an input/output line is available for communication with the one or more slave devices 104a-104n. A busy status of any of the plurality of input/output lines 106a-106f may indicate to the one or more processing cores 108a-108n that the input/output line is communicating with the one or more slave devices 104a-104n or is in a bus timeout state. An idle status of any of the plurality of input/output lines 106a-106f may indicate to the one or more processing cores 108a-108n that the input/output line is awaiting data or control signals to communicate with the one or more slave devices 104a-104n. Further, in any of the available, busy, or idle status of the plurality of input/output lines 106a-106f, a default state of the plurality of input/output lines 106a-106f may be a powered-ON state based on the activation of the plurality of input/output lines 106a-106f. In addition, a monitoring circuit associated with the corresponding set of input/output lines may be further configured to generate the control signal independent of the status of the set of input/output lines.

The one or more slave devices 104a-104n may be coupled to the SoC 102 via the plurality of input/output lines 106a-106f. Further, a communication between the one or more slave devices 104a-104n and the SoC 102 may be enabled based on the configuration of the corresponding one or more communication protocols in the peripheral interconnect subsystem 110. In an example, the slave devices 104a and 104b may be configured to operate on the I2C communication protocol. Thus, when the I2C communication protocol is configured in the input/output controller 114a, the slave devices 104a and 104b may be configured to communicate with the SoC 102. Examples of the slave devices 104a and 104b that support the I2C communication protocol may be a magnetometer, a gyro meter, a camera, or the like.

In further examples, the slave device 104n may be configured to operate on the SPI communication protocol. Thus, when the SPI communication protocol is configured in the input/output controller 114a, the slave device 104n may be configured to communicate with the SoC 102. Examples of the slave device 104n that support the SPI communication protocol may be sensors, display devices, memory devices, or the like.

The interrupt controller 112 may be configured to receive a plurality of interrupts from the peripheral interconnect subsystem 110. In other words, the interrupt controller 112 may be coupled to each monitoring circuit of the plurality of monitoring circuits 116a and 116b to receive the corresponding interrupt. Upon receiving the plurality of interrupts, the interrupt controller 112 may alert the one or more processing cores 108a-108n associated with the received plurality of interrupts to execute corrective actions, e.g., the bus clean-up sequence. In an example, when at least one of the input/output line 106a and the input/output line 106b deviates from the default state upon the lapse of the time-period, the interrupt controller 112 may receive the interrupt from the monitoring circuit 116a. The interrupt controller 112 may be an interrupt handler.

The interrupt controller 112 may further identify a processing core associated with each received interrupt. Thus, the interrupt controller 112 may provide the received interrupt to the identified processing core via the corresponding interrupt line. The interrupt controller 112 may further provide the interrupt to other processing cores that may be executing functions in conjunction with the functions associated with the processing core 108a. The interrupt controller 112 may be further configured to prioritize each received interrupt based on a level of criticality associated with the interrupt. In an example, the interrupts associated with a safety operation may be assigned the highest priority by the interrupt controller 112. The interrupt controller 112 may further flag a bit in a register associated with the interrupt controller 112 based on the received interrupt. Upon the execution of the bus clean-up sequence by the one or more processing cores 108a-108n, the interrupt controller 112 may clear the flagged bit in the register, thus clearing the generated interrupt. The interrupt controller 112 may be implemented by way of control registers, status registers, or the like.

Although FIG. 1 illustrates that the peripheral interconnect subsystem 110 includes two input/output controllers and two monitoring circuits (e.g., the input/output controllers 114a and 114b and the monitoring circuits 116a and 116b), the scope of the present disclosure is not limited to it. In further aspects, the peripheral interconnect subsystem 110 may include more than two input/output controllers and two monitoring circuits without deviating from the scope of the present disclosure. Similarly, the ‘n’ in each of the processing core 108n and the slave device 104n may be an integer that may be between a numerical range. The integer may be based on the applications of the electronic device 100.

FIG. 2 illustrates a block diagram of a peripheral interconnect subsystem in an electronic device, in accordance with certain aspects of the present disclosure. The peripheral interconnect subsystem of FIG. 2 is shown to be same as the peripheral interconnect subsystem 110 of FIG. 1. Further, the electronic device of FIG. 2 is shown to be same as the electronic device 100 of FIG. 1. FIG. 2 is described in conjunction with FIG. 1. The peripheral interconnect subsystem 110 is coupled to the processing core 108a and the interrupt controller 112. The peripheral interconnect subsystem 110 is further coupled to the slave devices 104a and 104b via the set of input/output lines 106a and 106b. The peripheral interconnect subsystem 110 is shown to include the input/output controller 114a, the monitoring circuit 116a, and a register bank 200. Though a detailed operation of the monitoring circuit 116a is explained in FIG. 2, it will be understood by a person skilled in the art that the monitoring circuit 116b is structurally and functionally similar to the monitoring circuit 116a. Further, a register bank may be associated with the input/output controller 114b. For the sake of simplicity of explaining FIG. 2 and in a non-limiting example, it is assumed that the input/output controller 114a is configured with the I2C communication protocol.

The register bank 200 may include a plurality of registers that may be configured to at least store current states of the input/output line 106a and the input/output line 106b, enable/disable generation of the interrupt, store a value of the time-period, enable the bits associated with the set of input/output lines 106a and 106b, or the like. The plurality of registers may include an input/output detection register 202, an enable register 204, a status register 206, and a timing register 208. Each of the input/output detection register 202, the enable register 204, the status register 206, and the timing register 208 may be associated with the input/output controller 114a. In certain aspects, the input/output detection register 202, the enable register 204, the status register 206, and the timing register 208 may be internal to the input/output controller 114a. In further aspects, each of the input/output detection register 202, the enable register 204, the status register 206, and the timing register 208 may be enabled by the protocol controller of the input/output controller 114a. In other words, the protocol controller may configure the bits of each of the input/output detection register 202, the enable register 204, the status register 206 and configure the value of the time-period in the timing register 208.

The input/output detection register 202 may be configured to enable or disable the generation of the interrupt by the monitoring circuit 116a. The input/output detection register 202 may be configured based on the configuration of the communication protocol on the input/output controller 114a by the host processor. The input/output detection register 202 may include a set of bits that may be configurable, e.g., with “0” or “1”, to enable or disable the generation of the interrupt. In an example, the input/output detection register 202 may be an 8-bit register. Of the 8 bits, 7 bits may be reserved for other operations, while the 8^{th} bit (e.g., the least significant bit) can be configured to either a logic high state (1) or a logic low state (0) to control the generation of the interrupt. Continuing the example, if the 8-bit register is configured to a value of 00 Hexadecimal (h), the generation of the interrupt may be disabled. Conversely, if the 8-bit register is configured to “01h”, the generation of the interrupt may be enabled. While “0” and “1” are used as examples, any bit within the input/output detection register 202 can be utilized for controlling (e.g., enable/disable) the generation of the interrupt, and the interpretation of “0” and “1” can change depending on the context; for example, a “0” could represent an enable state in certain aspects. In certain aspects, configuring the input/output detection register 202 can be either a user-configurable feature or a defined setting integrated into the configuration of the communication protocol.

The enable register 204 may include a plurality of bits, each of the plurality of bits may have a one-to-one association with the plurality of input/output lines 106a-106f shown in FIG. 1. In an example, where there are 32 input/output lines, the enable register 204 may include 32-bits, one bit associated with one input/output line. The plurality of bits of the enable register 204 may be configurable based on the communication protocol that is configured on the input/output controller 114a. For example, if the communication protocol configured on the input/output controller 114a utilizes the set of input/output lines 106a and 106b for a data transfer operation, a set of bits among the plurality of bits that is associated with the set of input/output lines 106a and 106b as per the one-to-one association may be enabled, whereas remaining bits of the plurality of bits that are associated with unutilized input/output lines of the input/output controller 114a may be disabled. In an example, if the input/output controller 114a is configured with the OSPI communication protocol, which utilizes 8 input/output lines for communication, 8 bits of the enable register 204 associated with the 8 input/output lines may be enabled, while remaining bits may remain disabled. Likewise, if the input/output controller 114a is configured with the I2C communication protocol, which utilizes the set of input/output lines 106a and 106b for communication, the set of bits of the enable register 204 associated with the set of input/output lines 106a and 106b may be enabled, while remaining bits may remain disabled. In other words, the set of bits associated with the set of input/output lines 106a and 106b may be enabled based on the configuration of the I2C communication protocol on the input/output controller 114a. Thus, the set of bits associated with the set of input/output lines 106a and 106b, whose state is to be monitored, is enabled. In certain examples, enabling the set of bits may correspond to configuring the set of bits to a logic high state. The disabled bits may be set to a logic low state. In further examples, enabling the set of bits may correspond to configuring the set of bits to a logic low state. The disabled bits may be set to a logic high state.

The status register 206 may include a plurality of bits, each of the plurality of bits may have a one-to-one association with the plurality of input/output lines 106a-106f shown in FIG. 1. Thus, a set of bits in the status register 206 is associated with the set of input/output lines 106a and 106b, for example, one-to-one association. The monitoring circuit 116a and/or the input/output controller 114a may be configured to monitor and control the status register 206. A bit in the status register 206 may be configured to indicate a current state of a corresponding input/output line of the plurality of input/output lines 106 a-106f. In an example, where there are 32 input/output lines, the status register 206 may include 32 bits configured to indicate current states of the 32 input/output lines. In an example, the current state may correspond to an electrical state of an input/output line indicating whether the input/output line is in a powered-ON state or a powered-OFF state.

In certain aspects, initially the plurality of bits of the status register 206 may be configured to an initial value, for example, a logic low state (0). When the input/output controller 114a is configured with the communication protocol, a set of bits in the status register 206 that is associated with the set of input/output lines 106a and 106b may change based on changes in the current state of the set of input/output lines 106a and 106b, for example, due to activation of the set of input/output lines 106a and 106b for data transfer. In other words, before the input/output controller 114a is configured with the communication protocol, the set of input/output lines 106a and 106b along with other input/output lines may be in a powered-OFF state (e.g., a logic low state), and the plurality of bits of the status register 206 may be configured to a logic low state as default. However, when the input/output controller 114a is configured with the communication protocol, the set of input/output lines 106a and 106b may change to a powered-ON state (e.g., a logic high state). Consequently, the monitoring circuit 116a and/or the input/output controller 114a may configure the set of bits in the status register 206 to indicate the current state of the set of input/output lines 106a and 106b. For example, the monitoring circuit 116a and/or the input/output controller 114a may enable the set of bits (e.g., configure to a logic high state) in the status register 206 to indicate the current state (e.g., powered-ON state) of the set of input/output lines 106a and 106b. In other words, a bit of the set of bits in the status register 206 may be configured to indicate a current state of a corresponding input/output line of the set of input/output lines 106a and 106b. However, if any of the set of input/output lines 106a and 106b fails to change to the default powered-ON state based on the input/output controller 114a being configured with the communication protocol, a corresponding bit of the set of bits in the status register 206 may remain configured to the initial value (e.g., the logic low state) to indicate the deviation of the corresponding input/output line from the default state.

The timing register 208 may be configured to store the value of the time-period. In an example, the timing register 208 may be a 32-bit register. The time-period may be configurable. In certain aspects, the time-period may be configured based on a frequency of the communication protocol. In an example, the frequency associated with the I2C communication protocol may be 100 KiloHertz (khz), 400 khz, 1 Mega Hertz (MHz), and 3.4 Mhz. Further, the slave devices 104 a and 104 b may be configured to operate at different speeds of the I2C communication protocol. The time-period may further be configured based on a response time of the slave devices 104a and 104b.

The monitoring circuit 116a may include a logic circuit 210, a timing circuit 212, and a control circuit 214. The monitoring circuit 116a may be further configured to monitor the current state of each of the set of input/output lines 106a and 106b. The monitoring circuit 116a may be further configured to generate the interrupt as explained herein.

The logic circuit 210 may be coupled to the set of input/output lines 106a and 106b, and may be configured to execute a logic operation on a current state of each input/output line of the set of input/output lines 106a and 106b. In certain aspects, the logic operation may be an AND operation. In an example, the logic circuit 210 can be an AND gate. In further examples, the logic circuit 210 can be a combinational logic circuit that implements AND logic. The logic circuit 210 may be further configured to generate the control signal based on the execution of the logic operation. The control signal may have the first state based on the current state of at least one input/output line of the set of input/output lines 106a and 106b deviating from the default state. The control signal may have a second state based on the current state of each input/output line of the set of input/output lines 106a and 106b being the default state. Further, the control signal having the second state may indicate that the set of input/output lines 106a and 106b are operating normally. The logic circuit 210 may be further configured to execute the logic operation independent of the status (e.g., a data transfer status) of the set of input/output lines 106a and 106b. In other words, the logic circuit 210 may generate the control signal having one of the first state or the second state irrespective of whether the set of input/output lines 106a and 106b is available, busy, or idle.

In an example, the current state of each of the set of input/output lines 106a and 106b may be a logic high state (1) when the I2C communication protocol is configured in the input/output controller 114a. Thus, when the logic circuit 210, which is coupled to the set of input/output lines 106a and 106b, executes an AND operation on the current state of each of the set of input/output lines 106a and 106b, the logic circuit 210 may generate the control signal having the second state. The current state of the set of input/output lines 106a and 106b may thus be the default state. However, if the current state of at least one of the set of input/output lines 106a and 106b deviates from the default state, e.g., transitions to a logic low state, the control signal transitions from the second state to the first state. In addition, if the current state of the set of input/output lines 106a and 106b is re-established to the default state, e.g., transitions from the logic low state to the logic high state, the control signal also transitions from the first state to the second state.

The timing circuit 212 may be loaded with the value of the time-period. For example, the timing register 208 may load the value of the time-period in the timing circuit 212 based on the configuration of the communication protocol in the input/output controller 114a. In certain aspects, the timing circuit 212 may be coupled to the logic circuit 210, and may receive the control signal. The timing circuit 212 may be configured to start based on the control signal having the first state. In other words, the timing circuit 212 may be configured to trigger based on the deviation of at least one of the set of input/output lines 106a and 106b from the default state, e.g., when the control signal transitions from the second state to the first state based on the deviation. The control signal having the first state for an extended time, e.g., upon the lapse of the time-period, may indicate a fault in at least one of the set of input/output lines 106a and 106b.

The timing circuit 212 may trigger based on the control signal having the first state, thereby enabling the timing circuit 212 to track a time duration for which the control signal remains in the first state. Further, the timing circuit 212 may be further configured to determine whether the control signal has transitioned from the first state to the second state prior to the lapse of the time-period. The control signal may transition from the first state to the second state based on a recovery of the set of input/output lines 106a and 106b to the default state. In an example, the recovery of the set of input/output lines 106a and 106b may occur based on the slave devices 104a and 104b releasing the logic low state of the set of input/output lines 106a and 106b. The timing circuit 212 may be further configured to reset upon determining that the control signal has transitioned from the first state to the second state prior to the lapse of the time-period. In other words, if the time duration of the control signal having the first state is lower than the time-period, the timing circuit 212 may reset. However, the timing circuit 212 may be further configured to generate a timeout signal upon determining that the control signal has the first state upon the lapse of the time-period. In other words, if the time duration of the control signal having the first state becomes equal to or exceeds the time-period, the timing circuit 212 may generate the timeout signal. In an example, the time-period may be 5 nanoseconds (ns). The timing circuit 212 may start upon receiving the control signal having the first state. If the control signal transitions from the first state to the second state prior to the lapse of 5 ns, the timing circuit 212 may reset. Alternately, if the control signal has the first state upon the lapse of 5 ns, the timing circuit 212 may generate the timeout signal.

In various aspects, the timing circuit 212 may include a counter such as an up-counter or a down-counter, or a timer that may increment or decrement based on the loaded value of the time-period. The counter or timer may start based on the control signal having the first state. Further, the counter or timer may reset based on the control signal transitioning from the first state to the second state before the lapse of the time-period.

In several aspects, the timing circuit 212 may include a determination circuit that may include suitable circuitry and/or code that may be configured to determine whether the control signal has transitioned from the first state to the second state prior to the lapse of the time-period. Though the timing circuit 212 may be implemented as a hardware circuit, in various aspects, the timing circuit 212 may be implemented by a software timer that monitors the control signal.

The control circuit 214 may include suitable circuitry and/or code that may be configured to execute a desired function based on a trigger to the control circuit 214. In an example, the desired function may be generation of the interrupt whereas the trigger may be the timeout signal. Thus, the control circuit 214 may be configured to receive the timeout signal. In various aspects, the control circuit 214 may be coupled to the timing circuit 212. Further, the reception of the timeout signal by the control circuit 214 may indicate to the control circuit 214 that at least one of the set of input/output lines 106a and 106b may be faulty.

The control circuit 214 may be further configured to generate the interrupt based on the received timeout signal. The control circuit 214 may be further configured to provide the interrupt to the interrupt controller 112. The interrupt controller 112 may provide the interrupt to the processing core 108a to trigger the bus clean-up sequence for the set of input/output lines 106a and 106b. In certain aspects, the control circuit 214 may be configured to configure the set of bits of the status register 206 upon the generation of the interrupt to indicate the current state of the set of input/output lines 106a and 106b. Examples of the control circuit 214 may include, but are not limited to, a processor, a microcontroller, a control and status register, or the like.

Upon receiving the interrupt from the control circuit 214 by way of the interrupt controller 112, the processing core 108a may execute the bus clean-up sequence. As part of the bus clean-up sequence, the processing core 108a may provide one or more clock pulses on a serial clock line, e.g., the input/output line 106b, that is faulty. In an example, at least one of the slave devices 104a and 104b may hold the input/output line 106a at a logic low state for an extended time duration that may lead to deviation of the input/output line 106a from the default state upon the lapse of the time-period. Upon receiving the clock pulses, the slave devices 104a and 104b may thus release the set of input/output lines 106a and 106b. Further, the input/output controller 114a may halt any data communication with the slave devices 104a and 104b and clear the queued buffers associated with the data communication during the bus clean-up. The processing core 108a may determine a success or failure of the clearing of the set of input/output lines 106a and 106b based on the bus clean-up sequence. In an event that the set of input/output lines 106a and 106b have been successfully released by the slave devices 104a and 104b, the deviated state of the set of input/output lines 106a and 106b is re-established to the default state, and the processing core 108a may cease to receive the interrupt and determine that the execution of the bus clean-up sequence is successful. Upon successful re-establishment of the default state of the set of input/output lines 106a and 106b, the processing core 108a may re-initiate the data transfer to the input/output controller 114a. A failure of the clean-up may occur when the set of input/output lines 106a and 106b remains in the deviated state. In such scenarios, the processing core 108a may re-initiate the bus clean-up sequence.

In certain examples, upon configuring the I2C communication protocol on the input/output controller 114a, the set of input/output lines 106a and 106b may be activated. The input/output line 106a may be a serial data line and the input/output line 106b may be a serial clock line. Further, the processing core 108a may be configured to initiate data transfer to the slave devices 104a and 104b via the input/output controller 114a and the the set of input/output lines 106a and 106b. A default state of the set of input/output lines 106a and 106b may be a logic high state indicating that the set of input/output lines 106a and 106b is available for data transfer.

In an example, the current state of the input/output line 106a may deviate from the default state prior to the data transfer. Thus, the logic circuit 210 may generate the control signal having the first state and the timing circuit 212 (e.g., the timer) may start. In an event that the current state of the input/output line 106a is re-established to the default state prior to the lapse of the time-period, the control signal may transition from the first state to the second state. Upon receiving the control signal having the second state prior to the lapse of the time-period, the timing circuit 212 may reset.

However, if the current state of the input/output line 106a remains in the deviated state upon the lapse of the time-period, the timing circuit 212 may timeout and generate the timeout signal. The control circuit 214 may receive the timeout signal, generate the interrupt, and provide the interrupt to the interrupt controller 112. The interrupt controller 112 may further provide the interrupt to the processing core 108a. The processing core 108a may trigger the bus-cleanup sequence to clear the deviated state of at least one of the set of input/output lines 106a and 106b and re-establish the default state (e.g., the logic high state) of the set of input/output lines 106a and 106b, such as the input/output line 106a. The logic circuit 210 may thus generate the control signal having the second state upon the re-establishment and the interrupt may be cleared. Based on the re-establishment of the default state of the set of input/output lines 106a and 106b, the processing core 108a may initiate/re-initiate the data transfer to the slave devices 104a and 104b via the input/output controller 114a and the set of input/output lines 106a and 106b.

In further examples, the processing core 108 a may load a 16-byte data packet into data buffers associated with the input/output controller 114a. The input/output controller 114a may process the 16-byte data packet based on the I2C communication protocol and transmit the 16-byte data packet in a single or a plurality of transactions to the slave devices 104a and 104b to execute the data transfer. During the data transfer, the current status of the set of input/output lines 106a and 106b may be a busy status. Further, the current state of each of the set of input/output lines 106a and 106b may be monitored by the monitoring circuit 116a during the data transfer. If any of the set of input/output lines 106a and 106b is stuck low for a time duration greater than the timeout period (e.g., bus timeout) due to at least one of the slave devices 104a and 104b being unable to process the received data packets, the logic circuit 210 may generate the control signal having the first state and the timing circuit 212 (e.g., the timer) may start. If the set of input/output lines 106a and 106b deviate from the default state upon the lapse of the time-period, the timing circuit 212 may generate the timeout signal. The timeout signal may cause the control circuit 214 to generate the interrupt, thus triggering the bus clean-up sequence.

It will be understood by a person skilled in the art that when the current status of the set of input/output lines 106a and 106b may be an idle status, the bus-cleanup sequence may be executed based on the deviation of the set of input/output lines 106a and 106b from the default state upon the lapse of the time-period. Further, the generation of the control signal, the timeout signal, the interrupt, the bus clean-up sequence, and the re-establishment of the set of input/output lines 106a and 106b occurs in a manner similar as described in the foregoing description.

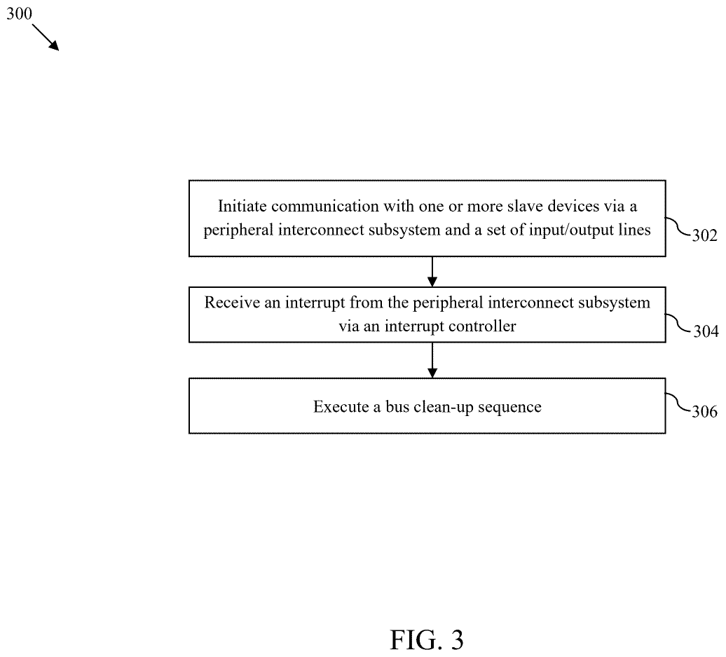

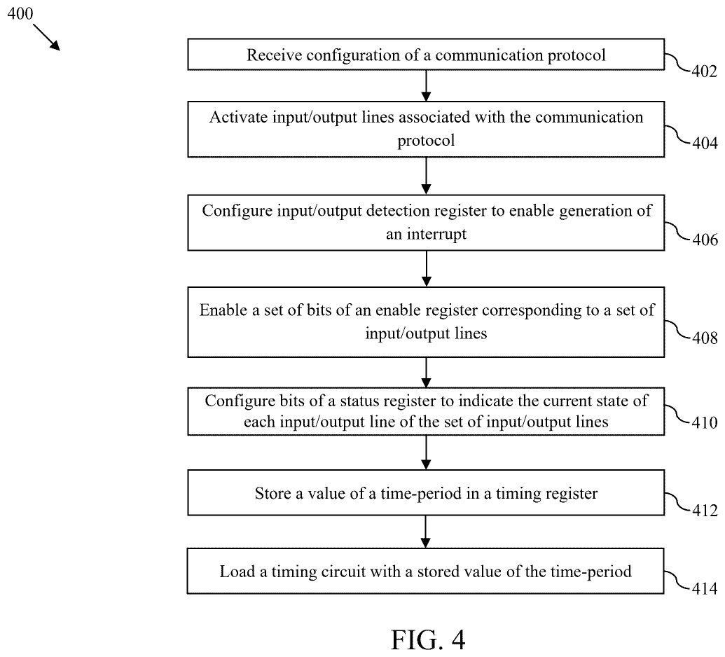

FIG. 3 is a flowchart 300 that illustrates a method (e.g., a process) executed by the one or more processing cores 108a-108n, in accordance with an exemplary aspect of the present disclosure. For the sake of simplicity, the flowchart 300 is explained with reference to the processing core 108a, the slave devices 104a and 104b, the set of input/output lines 106a and 106b, and the input/output controller 114a. In addition, FIGS. 4-7 are explained with reference to the processing core 108a, the slave devices 104a and 104b, the set of input/output lines 106a and 106b, and the input/output controller 114a.

At 302, a communication with one or more slave devices via a peripheral interconnect subsystem and a set of input/output lines may be initiated. The processing core 108a may initiate the communication with the slave devices 104a and 104b via the peripheral interconnect subsystem 110 and the set of input/output lines 106a and 106b. The processing core 108a may initiate the communication based on the configuration of the input/output controller 114a with the communication protocol. The current state of the set of input/output lines 106a and 106b may be the default state or the deviated state during any of the available, busy, or idle status of the set of input/output lines 106a and 106b. Based on the current state of the set of input/output lines 106a and 106b being in the deviated state upon the lapse of the time-period, the interrupt may be generated.

At 304, the interrupt may be received from the peripheral interconnect subsystem via an interrupt controller. The processing core 108a may receive the interrupt from the interrupt controller 112. The reception of the interrupt may indicate a fault in at least one input/output line of the set of input/output lines 106a and 106b.

At 306, a bus clean-up sequence may be executed. The processing core 108a may execute the bus clean-up sequence to clear the deviated state of the set of input/output lines 106a and 106b and re-establish the default state of the set of input/output lines 106a and 106b.

FIG. 4 is a flowchart 400 that illustrates a method (e.g., a process) executed based on a configuration of a communication protocol on the input/output controller 114a, in accordance with an exemplary aspect of the present disclosure.

At 402, a configuration of a communication protocol may be received. The input/output controller 114a may be configured to receive the configuration of the communication protocol. At 404, input/output lines associated with the communication protocol may be activated. For example, the set of input/output lines 106a and 106b associated with the communication protocol may be activated upon the configuration of the communication protocol in the input/output controller 114a. For the simplicity of explanation of the flowchart 400 and in a non-limiting example, the set of input/output lines 106a and 106b may be set at the default state, e.g., a logic high state, based on the activation.

At 406, an input/output detection register may be configured to enable generation of an interrupt. The input/output detection register 202 may be associated with the input/output controller 114a. The input/output detection register 202 may be configured upon the reception of the configuration of the communication protocol. In other words, the set of bits of the input/output detection register 202 may be configured, for example, set to a logic high state (1), to enable the generation of the interrupt.

At 408, a set of bits of an enable register corresponding to a set of input/output lines may be enabled. The enable register 204 may be associated with the input/output controller 114a. Based on the communication protocol that may be configured in the input/output controller 114a, the set of bits of the enable register 204 corresponding to the set of input/output lines 106a and 106b associated with the communication protocol may be enabled.

At 410, bits of a status register may be configured to indicate the current state of each input/output line of the set of input/output lines. The status register 206 may be associated with the input/output controller 114a. In one example, the current state of each input/output line of the set of input/output lines 106a and 106b may be the default state, e.g., a logic high state, upon the configuration of the communication protocol. Thus, a bit of the set of bits of the status register 206 may be configured to indicate the current state of a corresponding input/output line of the set of input/output lines 106a and 106b. In other words, the set of bits may be at a logic low state or a logic high state depending on the current state of the set of input/output lines 106a and 106b.

At 412, a value of a time-period in a timing register may be stored. The timing register 208 may be associated with the input/output controller 114a. The value of the time-period may be configurable and based on the communication protocol that is configured.

At 414, a timing circuit may be loaded with the stored value of the time-period. The timing register 208 may load the stored value of the time-period to the timing circuit 212. For example, the stored value of the time-period may be loaded to a timer of the timing circuit 212.

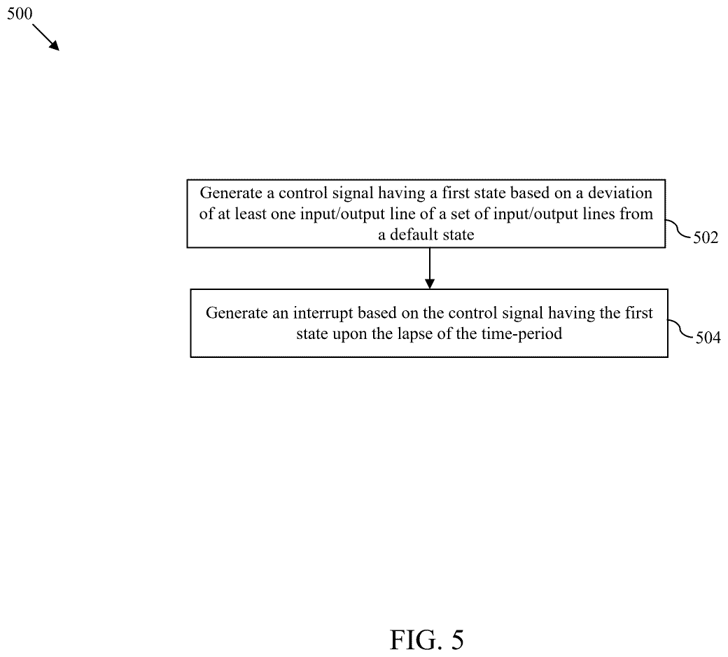

FIG. 5 is a high-level flowchart 500 that illustrates a method (e.g., a process) executed at the peripheral interconnect subsystem 110, in accordance with an exemplary aspect of the present disclosure.

At 502, a control signal having a first state based on a deviation of at least one input/output line of a set of input/output lines from a default state may be generated. The set of input/output lines 106a and 106b may couple the input/output controller 114a in the peripheral interconnect subsystem 110 to the one or more slave devices 104a and 104b. Thus, if any of the set of input/output lines deviates from the default state, the monitoring circuit 116a of the peripheral interconnect subsystem 110 generates the control signal having the first state.

At 504, an interrupt based on the control signal having the first state upon the lapse of the time-period may be generated. The monitoring circuit 116a may generate the interrupt based on the control signal having the first state upon the lapse of the time-period.

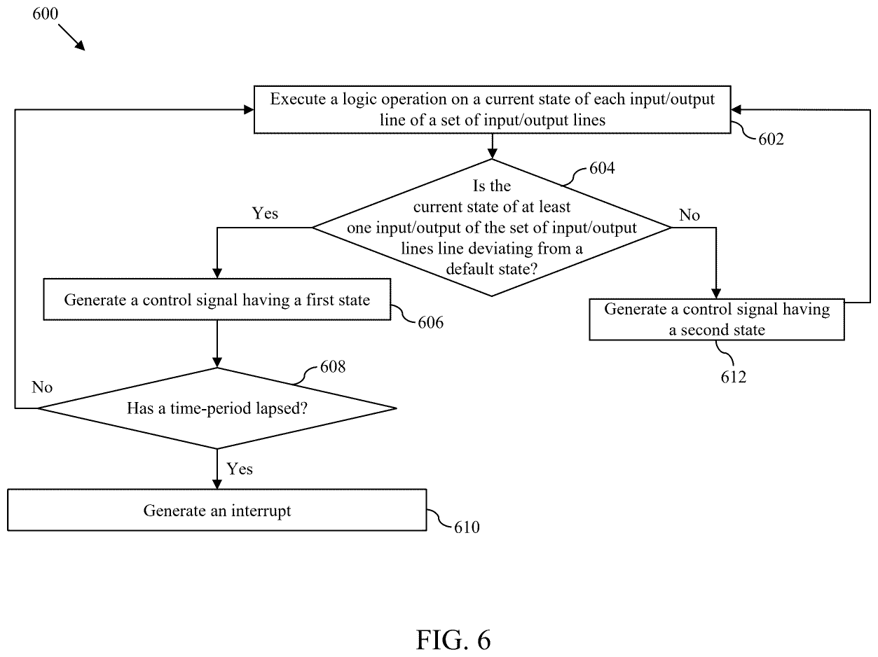

FIG. 6 is a detailed flowchart 600 that illustrates a method (e.g., a process) executed by the monitoring circuit 116a, in accordance with an exemplary aspect of the present disclosure.

At 602, a logic operation on a current state of each input/output line of a set of input/output lines may be executed. The logic circuit 210 may be coupled to the set of input/output lines 106a and 106b. Thus, inputs to the logic circuit 210 may be the current states (e.g., logic high or logic low) of the set of input/output lines 106a and 106b. The current states may refer to electrical states of the set of input/output lines 106a and 106b. The logic operation may be executed at any of idle, busy, or available status of the set of input/output lines 106a and 106b.

At 604, it is determined whether the current state of at least one input/output line of the set of input/output lines has deviated from a default state. If it is determined that the current state of the at least one input/output line has deviated from the default state, 606 is executed. In an example, the determination of whether the current state of the at least one input/output line has deviated from the default state is based on a result of the logic operation.

At 606, a control signal having a first state may be generated. The logic circuit 210 may generate the control signal having the first state. The timing circuit 212 may receive the control signal having the first state. The timer of the timing circuit 212 may start upon receiving the control signal having the first state.

At 608, it is determined whether a time-period has lapsed. The timing circuit 212 may further determine whether the time-period has lapsed upon receiving the control signal having the first state. If it is determined that the time-period has not lapsed, 602 is executed. If it is determined that the time-period has lapsed, 610 is executed.

At 610, an interrupt may be generated. The control circuit 214 may generate the interrupt based on the control signal having the first state upon the lapse of the time-period. The control signal having the first state upon the lapse of the time-period may be indicative of a fault in at least one of the set of input/output lines 106a and 106b. A bus-clean-up sequence may be triggered based on the interrupt.

At 604, if it is determined that the current state of the set of input/output lines is the same as the default state, 612 is executed. At 612, the control signal having the second state is generated. The logic circuit 210 may generate the control signal having the second state based on the current state of the set of input/output lines being the default state. The bits of the status register 206 may be configured by the control circuit 214 based on the current state of the set of input/output lines 106a and 106b being in the default state or deviated state.

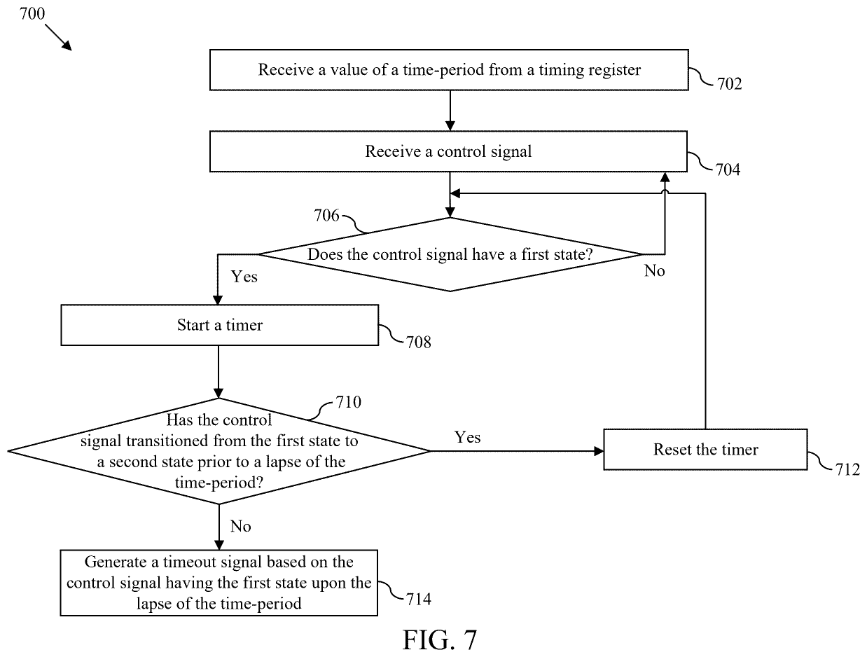

FIG. 7 is a flowchart 700 that illustrates a method (e.g., a process) executed by the timing circuit 212, in accordance with an exemplary aspect of the present disclosure.

At 702, a value of a time-period from a timing register may be received. The timing circuit 212 may receive the value of the time-period based on the configuration of the time-period in the timing register 208. The value may be based on the type of communication protocol.

At 704, a control signal may be received. The timing circuit 212 may receive the control signal from the logic circuit 210. The control signal may be received at any of idle, free, or available status of the set of input/output lines 106a and 106b. A state of the control signal may be indicative of whether there is any fault in any of the set of input/output lines 106a and 106b. The control signal may have the first state or the second state.

At 706, it is determined whether the control signal has the first state. The timing circuit 212 may determine whether the control signal has the first state upon receiving the control signal. The control signal may have the first state based on the current state of at least one of the set of input/output lines 106a and 106b deviating from the default state. The default state may be a powered-ON state or a logic high state.

At 708, the timer may start. The timer of the timing circuit 212 may start based on the determination that the control signal has the first state. In other words, the timer of the timing circuit 212 may start upon receiving the control signal having the first state.

At 710, it is determined whether the control signal has transitioned from the first state to a second state prior to a lapse of the time-period. The timing circuit 212 may determine whether the control signal has transitioned from the first state to the second state.

At 712, the timer may be reset. The timer of the timing circuit 212 may be reset based on the determination that the control signal has transitioned from the first state to the second state prior to the lapse of the time-period. Control passes to 706.

If at 710, it is determined that the control signal has the first state upon the lapse of the time-period, 714 is executed. At 714, a timeout signal may be generated based on the control signal having the first state upon the lapse of the time-period. The timing circuit 212 may generate the timeout signal based on the control signal having the first state upon the lapse of the time-period. The control signal retains the first state upon the lapse of the time-period based on a fault in at least one of the set of input/output lines 106a and 106b.

Techniques consistent with the present disclosure provide, among other features, systems, and methods for recovering faulty peripheral input/output lines.

Aspects in the present disclosure provide the electronic device 100 and a method for recovering at least one of the plurality of input/output lines 106a-106f thereby re-establishing a default state of the one or more recovered input/output lines. The present disclosure presents a solution to eliminate polling of timers by the one or more processing cores 108a-108n such that the one or more processing cores 108a-108n remain free to execute further operations once data packets are loaded to data buffers. The constant polling by the one or more processing cores 108a-108n is eliminated as fault detection is offloaded to the plurality of monitoring circuits 116a and 116b. Thus, the one or more processing cores 108a-108n may execute further operations after loading data to the peripheral interconnect subsystem 110 for communication with the one or more slave devices 104a-104n. Further, a processing overhead on the one or more processing cores 108a-108n is reduced as compared when the one or more processing cores 108a-108n execute fault detection.

The peripheral interconnect subsystem 110 is further configured to concurrently operate in multiple execution environments associated with the one or more processing cores 108a-108n. The peripheral interconnect subsystem 110 may be further configured with multiple serial protocols such as I2C, I3C SPI, QSPI, OSPI, Q2SPI, XSPI, UART, or the like. The peripheral interconnect subsystem 110 may notify the one or more processing cores 108a-108n upon the generation of the interrupt by way of the interrupt controller 112. The peripheral interconnect subsystem 110 may further cancel the data transfer to the one or more slave devices 104a-104n by clearing the associated data buffers upon the generation of the interrupt. The peripheral interconnect subsystem 110 may further be able to capture the current states of the plurality of input/output lines 106a-106f during any of an available, busy, or idle status of the plurality of input/output lines 106a-106f.

The timing circuit 212 of the peripheral interconnect subsystem 110 may be configurable based on the communication protocol that is configured in the peripheral interconnect subsystem 110. Thus, the timing circuit 212 can be configured with various values of the time-period. The logic circuit 210 may generate the control signal in real-time or near real-time based on the current states of the set of input/output lines 106a and 106b thereby eliminating a dependence on constantly monitoring any register status for the deviation and further reducing latency in the generation of the interrupt over conventional systems. Further, the interrupt controller 112 may receive the interrupts from multiple control circuits such as the control circuit 214, and manage and provide the interrupts to the associated one or more processing cores 108a-108n. The enabled bits of the plurality of registers of the register bank 200 may be accessed by various components of the SoC 102 to detect a status of the plurality of input/output lines 106a-106f and thereby diagnosing the occurrence of faults in any of the plurality of input/output lines 106a-106f. Due to the aforementioned solutions, the peripheral interconnect subsystem 110 provides improved reliability, reduces the overall power consumption, and improves a performance of the SoC 102 over conventional systems for fault recovery.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A peripheral interconnect subsystem, comprising:
an input/output controller coupled to one or more slave devices via a set of input/output lines; and
a monitoring circuit coupled to the set of input/output lines, wherein the monitoring circuit is configured to:
generate a control signal having a first state based on a deviation of at least one input/output line of the set of input/output lines from a default state; and
generate an interrupt based on the control signal having the first state upon a lapse of a time-period.

2. The peripheral interconnect subsystem of claim 1, wherein the monitoring circuit is further configured to generate the control signal based on a logic operation.

3. The peripheral interconnect subsystem of claim 2, wherein the logic operation is an AND operation.

4. The peripheral interconnect subsystem of claim 2, wherein the monitoring circuit is further configured to generate the control signal having one of:
the first state based on a current state of the at least one input/output line of the set of input/output lines deviating from the default state, or
a second state based on the current state of each input/output line of the set of input/output lines being the default state.

5. The peripheral interconnect subsystem of claim 2, wherein the monitoring circuit is further configured to generate the control signal independent of a status of the set of input/output lines, and wherein the status of the set of input/output lines is one of available, busy, or idle.

6. The peripheral interconnect subsystem of claim 2, wherein the monitoring circuit comprises a timing circuit configured to:
start based on the control signal having the first state; and
determine whether the control signal transitions from the first state to a second state prior to the lapse of a time-period or has the first state upon the lapse of the time-period.

7. The peripheral interconnect subsystem of claim 6, wherein the timing circuit is further configured to reset based on the determination that the control signal transitions from the first state to the second state prior to the lapse of the time-period.

8. The peripheral interconnect subsystem of claim 6, wherein the timing circuit is further configured to generate a timeout signal based on the control signal having the first state upon the lapse of the time-period.

9. The peripheral interconnect subsystem of claim 8, wherein the monitoring circuit is further configured to generate the interrupt further based on the timeout signal, wherein the interrupt triggers a bus clean-up sequence for the set of input/output lines.

10. The peripheral interconnect subsystem of claim 6, further comprising a timing register associated with the input/output controller, wherein the timing register is configured to:
store a value of the time-period; and
load the timing circuit with the stored value of the time-period.

11. The peripheral interconnect subsystem of claim 1, further comprising an input/output detection register associated with the input/output controller, wherein the input/output detection register is configured to enable the generation of the interrupt.

12. The peripheral interconnect subsystem of claim 1, further comprising an enable register associated with the input/output controller, wherein the enable register includes a set of bits corresponding to the set of input/output lines.

13. The peripheral interconnect subsystem of claim 1, further comprising a status register associated with the input/output controller, wherein the status register includes a set of bits corresponding to the set of input/output lines, and wherein a bit of the set of bits is configured to indicate a current state of a corresponding input/output line of the set of input/output lines.

14. The peripheral interconnect subsystem of claim 1, wherein the input/output controller is configured to control data transfer between at least one execution environment and the one or more slave devices via the set of input/output lines.

15. The peripheral interconnect subsystem of claim 1, further comprising:
a plurality of input/output controllers that comprises the input/output controller; and
a plurality of monitoring circuits that comprises the monitoring circuit, wherein each monitoring circuit of the plurality of monitoring circuits is associated with a corresponding input/output controller of the plurality of input/output controllers.

16. A system-on-chip (SoC), comprising:
one or more processing cores; and
a peripheral interconnect subsystem coupled between the one or more processing cores and one or more slave devices, wherein the peripheral interconnect subsystem comprises:
at least one input/output controller coupled to the one or more slave devices via a set of input/output lines, wherein the at least one input/output controller is configured to control data transfer between at least one processing core of the one or more processing cores and the one or more slave devices via the set of input/output lines; and
at least one monitoring circuit coupled to the set of input/output lines, wherein the at least one monitoring circuit is configured to:
generate a control signal having a first state based on a deviation of at least one input/output line of the set of input/output lines from a default state; and
generate an interrupt based on the control signal having the first state upon a lapse of a time-period.

17. The SoC of claim 16, wherein the one or more processing cores are configured to:
receive the interrupt; and
execute a bus clean-up sequence for the set of input/output lines based on the received interrupt.

18. A method executed at a peripheral interconnect subsystem, the method comprising:
generating a control signal having a first state based on a deviation of at least one input/output line of a set of input/output lines from a default state, wherein the set of input/output lines couple an input/output controller in the peripheral interconnect subsystem to one or more slave devices; and
generating an interrupt based on the control signal having the first state upon a lapse of a time-period.

19. The method of claim 18, further comprising generating the control signal having a second state based on a current state of each input/output line of the set of input/output lines being the default state.

20. The method of claim 18, wherein the control signal is generated independent of a status of the set of input/output lines, and wherein the status of the set of input/output lines is one of available, busy, or idle.
